(19) United States
(12) Patent Application Publication
(10) Pub. No.: US 2026/0218824 A1
(43) Pub. Date: Jul. 30, 2026

(54) FLUIDIC DEFLECTION UNIT AND USE OF A TUBE

(71) Applicant: Neoperl GmbH, Müllheim (DE)

(72) Inventors: Marc TEMPEL, Freiburg (DE); Werner KURY, Müllheim (DE); Holger SCHÜRLE, Müllheim (DE); Jochen MÜNDLEIN, Merdingen (DE)

(73) Assignee: Neoperl GmbH, Müllheim (DE)

(21) Appl. No.: 19/145,252

(22) PCT Filed: Dec. 22, 2023
(86) PCT No.: PCT/EP2023/087643

§ 371 Date: Jul. 2, 2025

(30) Foreign Application Priority Data
Jan. 23, 2023 (DE) 20 2023 100 312.5

(51) Int. Cl. F16L 33/22; F16L 43/00

(52) U.S. Cl. CPC F16L 33/227; F16L 43/00

(57) ABSTRACT

A fluidic deflection unit (1), in particular for use in the sanitary sector, having a housing (2), two hose receptacles (3, 4) and a connecting channel (5) fluidically connecting the hose receptacles (3, 4). The hose receptacles (3, 4) are connected fluidically together, in particular in at least one axial portion (8), beyond the connecting channel (5), in particular, the hose receptacles (3, 4) and the connecting channel (5) are respectively arranged such that they are separable by a plane (9).

### CROSS-REFERENCE TO RELATED APPLICATIONS

This application is a 371 National Phase of International Application No. PCT/EP2023/087643, filed Dec. 22, 2023, which claims priority from German Patent Application No. 10 2023 100 312.5, filed Jan. 23, 2023, both of which are incorporated herein by reference as if fully set forth.

### TECHNICAL FIELD

The invention relates to a fluidic deflection unit having a housing, two hose receptacles and a connecting channel fluidically connecting the hose receptacles. The fluidic deflection unit can be provided in particular for use in the sanitary sector.

The invention also relates to the use of a hose for interrupting a fluidic connection in a fluidic deflection unit according to the invention.

### BACKGROUND

Such deflection units are known and are used to connect two hoses together and in the process to bring about a change in the direction of flow of the fluid.

DE 10 2020 127375 A1 discloses the use of a hose for fluidically connecting an outlet piece to a valve of a sanitary fitting, wherein the outlet piece is able to be fixedly connected to the sanitary fitting, wherein the hose extends between the outlet piece and the valve-side end thereof in a portion outside a housing of the sanitary fitting.

### SUMMARY

The invention addresses the problem of making it easier to manufacture, assemble and use such deflection units.

To solve the abovementioned problem, the invention provides one or more of the features disclosed herein in a fluidic deflection unit. In particular, to solve the abovementioned problem in fluidic deflection units of the type described at the beginning, the invention thus proposes that the hose receptacles are connected fluidically together beyond the connecting channel.

Thus, a fluidic connection of the hose receptacles that is separate from the connecting channel is formed. This fluidic connection exists at least and in particular only when no hose has been inserted into the hose receptacle. Preferably, this fluidic connection is interrupted as soon as a hose is inserted.

In this case, provision may be made for the hose receptacles to be connected fluidically together in at least one axial portion beyond the connecting channel. Alternatively or additionally, provision may be made for the hose receptacles and the connecting channel to be respectively arranged such that they are separable by a plane. The fluidic deflection unit is designed to be used with two inserted hoses in the assembled position.

In this way, the manufacture and assembly of fluidic deflection units can be simplified. Fluidic deflection units can be embodied without an undercut in this way, thereby further simplifying the manufacture and assembly thereof.

In an advantageous configuration, provision may be made for the fluidic deflection unit to have a one-piece housing.

When the fluidic deflection unit is manufactured without an undercut, it is possible to dispense with a multi-part embodiment with the housing being put together downstream. One-piece manufacture is thus possible and simplifies the manufacturing and assembly process.

According to a first embodiment of the invention, provision is made for a sealing element that acts in both hose receptacles to at least partially fill the fluidic connection. Alternatively or additionally, in a second embodiment of the invention, provision is made for the sealing element to consist of two mutually connected rings. These may be, for example, O-rings, X-rings and/or rings with a rectangular cross-sectional area. The rings can be connected together via a connecting web. The connecting web can in this case be considered in particular to be the region that is connected integrally to the rings and is located outside the respective outer circumference of the rings. This connecting web is preferably adapted to the fluidic deflection unit such that it at least partially fills the fluidic connection so as to achieve optimal sealing.

Therefore, only one sealing element is necessary for sealing the two hose receptacles. The sealing element is in this case intended to fill a space between a hose to be fitted, i.e. a hose that is fitted in the assembled position of the fluidic deflection unit, and the housing of the fluidic deflection unit. At the same time, an intermediate space that exists between the hoses that have been inserted in the assembled position is able to be filled and sealed.

In an advantageous configuration, provision may be made for the hose receptacles to be connected fluidically together along their entire course in the axial direction.

In this case, the course of the hose receptacles can be considered in particular to be a housing portion in which each hose receptacle has a constant diameter. Individual ones of the two connected hose receptacles can be considered to be, for example, respective cylindrical portions. If the respective hose receptacles have been connected fluidically together along their entire course in the axial direction, this results in a particular simplification of the manufacture of the fluidic deflection unit.

In an advantageous configuration, provision may be made for a fluidic connection, fluidically connecting the hose receptacles, for example the abovementioned fluidic connection, and the connecting channel to form a common interior of the housing. Thus, the interior is able to be filled with a simple tool during production. Preferably, this interior is simply connected in the mathematical sense. Thus, a one-piece configuration is able to be produced particularly easily without an undercut.

In an advantageous configuration, provision may be made for respective longitudinal axes of the hose receptacles to be oriented parallel to respective longitudinal axes of openings at the ends of the connecting channel. In addition, provision may be made for respective longitudinal axes of the hose receptacles to be oriented congruently with respective longitudinal axes of the openings in the connecting channel.

In this way, optimal orientation of the hoses with the openings in the connecting channel can be achieved. As a result, advantageous flow properties particularly in the region of the fluidic direction reversal are achievable.

In an advantageous configuration, provision may be made for a sleeve part to have been inserted into the housing and to be designed to axially guide a hose that is able to be fitted in the hose receptacle. In addition, provision may be made for the sleeve part to have been inserted into a or the hose receptacles. Alternatively or additionally, provision may be made for the sleeve part to be latched or able to be latched together with the housing.

In this way, radially acting forces, which can be introduced for example by bending the hose, can be absorbed by the sleeve. This makes it possible to prevent the forces acting radially or transversely to the fitting direction to be applied to the sealing element such that the sealing action is reduced. It is particularly advantageous for the size of hose feedthroughs through the sleeve part to be adapted to the hoses to be fitted such that the contact surface of the hose with the sleeve part corresponds approximately to outer circumferential surface of the hose. In this way, the respective hose can be guided optimally and the absorption of forces acting transversely to the fitting direction by the fluidic deflection unit is facilitated.

In an advantageous configuration, provision may be made for the sleeve part to have at least one latching cam. In addition, provision may be made for the sleeve part to have at least one latching cam and preferably two opposite latching cams per hose receptacle.

In this way, a simple latching possibility for the sleeve part can be realized, such that the latter can be fixed securely.

In an advantageous configuration, provision may be made for the at least one latching cam to be able to act together with an appropriately designed receiving opening in the housing such that the sleeve part is able to be latched together with the housing.

Thus, the sleeve part can be fixed securely to the housing. The sleeve part may, for example, as an end part, fix the further parts located in the interior of the housing in their location and protect them from dropping out or off.

In an advantageous configuration, provision may be made for the sleeve part to comprise at least one holding part, which holding part is able to be fitted on a hose that is able to be fitted in the hose receptacle and is able to be fitted in a holding-part receptacle of the sleeve part. In addition, provision may be made for the holding part to be able to be latched in place in a holding-part receptacle of the sleeve part.

In this way, even better guidance of the hoses to be fitted can be achieved. The hoses can also additionally be secured against being pulled out.

In an advantageous configuration, provision may be made for the holding part to have a receiving opening for a hose and to entirely enclose same in the circumferential direction.

The hose is thus able to be received in the holding part, wherein the receiving opening and thus the hose are entirely enclosed in the circumferential direction. Thus, the guidance of the hose and the absorption of transversely acting forces by the fluidic deflection unit are improved.

In an advantageous configuration, provision may be made for a or the sealing element to have been fitted in the housing and to be designed to externally seal two hoses that are able to be fitted in the hose receptacles. In addition, provision may be made for the sealing element to be embodied in the form of two mutually connected rings. These may be, for example, O-rings, X-rings and/or rings with a rectangular cross-sectional area. Alternatively or additionally, provision may be made for the sealing element to be arranged next to a or the sleeve part.

The sealing element can thus be adapted optimally to the hoses to be inserted. The sealing element can also be fixed relative to the housing of the fluidic deflection unit by the sleeve part. For example, it is also possible for a plurality of sealing elements to be arranged one above another.

In an advantageous configuration, provision may be made for an insert part to have been inserted into the housing and to form a planar support surface transversely to the direction of a longitudinal axis of a hose receptacle on the side thereof remote from a housing opening. In addition, provision may be made for the insert part to be arranged next to a or the sealing element.

In this way, the sealing element can be fixed on its two sides between the sleeve part and holding part relative to the housing. Furthermore, a remaining space in the hose receptacle is able to be filled by the insert part such that a free space can be avoided when hoses have been fitted. Thus, the space available for the fluid flowing through can be reduced. In this way, it is possible to prevent the formation of air bubbles in this free space, which would result in a turned-off probe housing continuing to run. Furthermore, the lateral or radial stabilization and guidance of a fitted hose can be improved. The stabilization and guidance of the hose is increased with increasing fitting depth of the hose.

In an advantageous configuration, provision may be made for a holding element to be formed on a side, remote from a housing opening, of a hose receptacle in order to fix a hose that is able to be fitted in the hose receptacle. In addition, provision may be made for the holding element to consist of at least one toothed ring. Alternatively or additionally, provision may be made for the holding element to be embodied in the form of an insert part. Alternatively or additionally, provision may be made for a counter bearing for the holding element to be formed adjacent to the holding element. The counter bearing may be an insert part.

In this way, the hoses to be fitted can be fixed advantageously in the fluidic deflection unit. By means of the holding element, a hose to be fitted can be subjected to a force acting in the axial direction of the hose, in particular which force counteracts any pulling out of the hose. The hoses to be fitted can, depending on the requirements, be fixed in a region facing a housing opening or a region facing away from a housing opening, in particular in each case with regard to a sealing element.

In an advantageous configuration, provision may be made for the sleeve part and/or the holding part and/or the insert part and/or the holding element to be embodied in one piece for both hose receptacles. Alternatively or additionally, provision may be made for one or more of the abovementioned parts to at least partially fill the fluidic connection.

In this way, the manufacture of the abovementioned parts can be simplified. This likewise applies to the putting together of the fluidic deflection unit and the assembly thereof on the hoses.

In an advantageous configuration, provision may be made for the sleeve part and/or the holding part and/or the insert part and/or the holding element to be embodied separately for each hose receptacle.

In this case, in a fluidic deflection unit, a combination of parts embodied separately and in one piece is also possible.

In an advantageous configuration, provision may be made for the housing to have, externally, at least one reinforcing rib. Preferably, there are three reinforcing ribs. In this case, provision may be made for a or the reinforcing ribs to extend transversely to a fitting direction of a hose.

As a result of the fluidic connection of a hose receptacle in the axial direction, it may be possible to dispense with a partition wall between the hose receptacles. In this case, it is possible that, as a result of the omission of the partition wall, an instability of the fluidic deflection unit or of its housing arises. This instability can be compensated by the formation of at least one reinforcing rib and restored. As a result of the realization of reinforcing ribs, the stability of the housing can thus be increased.

In one configuration, provision may be made for a filling protrusion to be formed, which projects toward the connecting channel. It is advantageous here that dead space in which water is not flushed out or is not fully flushed out during use can be reduced. For example, provision may be made for the filling protrusion to at least partially fill an intermediate space between ends of the fitted hoses. A height of the filling protrusion can be, for example, a multiple of a material thickness of a carrier, for example of the abovementioned insert part.

For example, the filling protrusion can be formed on a, for example the abovementioned, insert part. In this way, the dead space can be reduced particularly easily.

Alternatively or additionally, to solve the abovementioned problem, the invention provides the features of the additional independent claim, directed to the use of a hose for interrupting a fluidic connection in a fluidic deflection unit as described above. In particular, to solve the abovementioned problem in uses of the type described at the beginning, the invention thus proposes that the hose is fitted in a hose receptacle into which the fluidic connection leads. In addition, provision may be made for the connecting channel to continue to be open in this case.

In this way, the advantages of fluidic deflection units according to the invention can be used in uses as described above. Since a hose interrupts a fluidic connection in a fluidic deflection unit, it may be possible to dispense, for example, with a partition wall within the fluidic deflection unit. In this way, simplified and preferably one-piece manufacture of the fluidic deflection unit can take place. The interrupted fluidic connection is, in this case, in particular the above-described connection between two hose receptacles of the fluidic deflection unit. In addition, a connecting channel, in particular the above-described connecting channel, can continue to continue to remain open.

### BRIEF DESCRIPTION OF THE DRAWINGS

The invention will now be described in more detail by way of an exemplary embodiment, but is not restricted to the exemplary embodiment. Further exemplary embodiments will become apparent by combining the features of individual and multiple claims with one another and/or with individual and multiple features of the exemplary embodiment.

In the figures:

FIG. 1 shows a perspective view of a fluidic deflection unit according to the invention with two hose ends fitted in it,

FIG. 2 shows a perspective view of a further fluidic deflection unit according to the invention with two hose ends fitted in it,

FIG. 3 shows a sectional view of a fluidic deflection unit according to the invention according to FIG. 1,

FIG. 4 shows a sectional view of a fluidic deflection unit according to the invention according to FIG. 2,

FIG. 5 shows a sectional view of a further fluidic deflection unit according to the invention according to FIG. 1,

FIG. 6 shows a further sectional view of the fluidic deflection units illustrated in FIGS. 3 to 5,

FIG. 7 shows an exploded illustration of the fluidic deflection unit illustrated in FIG. 3,

FIG. 8 shows an exploded illustration of the fluidic deflection unit illustrated in FIG. 4, and

FIG. 9 shows an exploded illustration of the fluidic deflection unit illustrated in FIG. 5.

### DETAILED DESCRIPTION

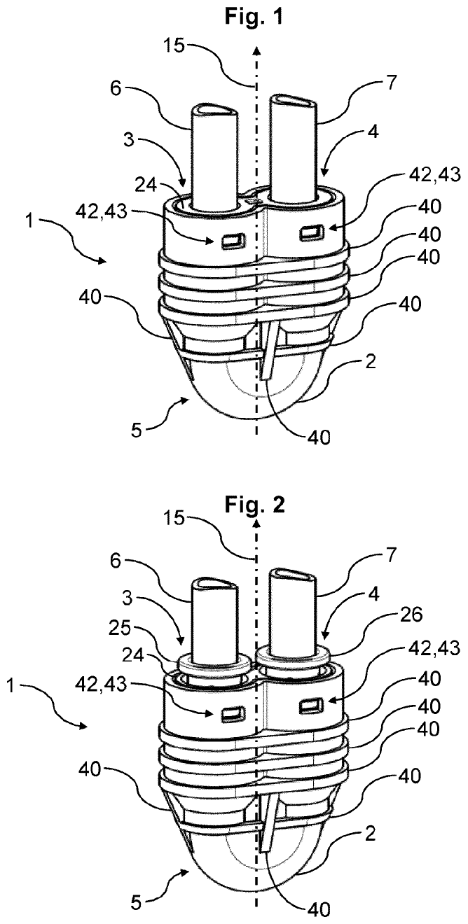

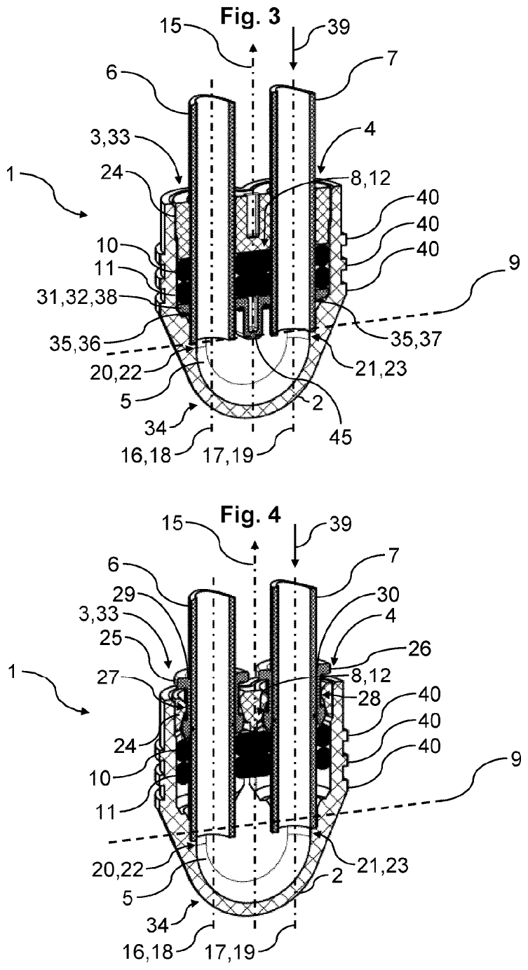

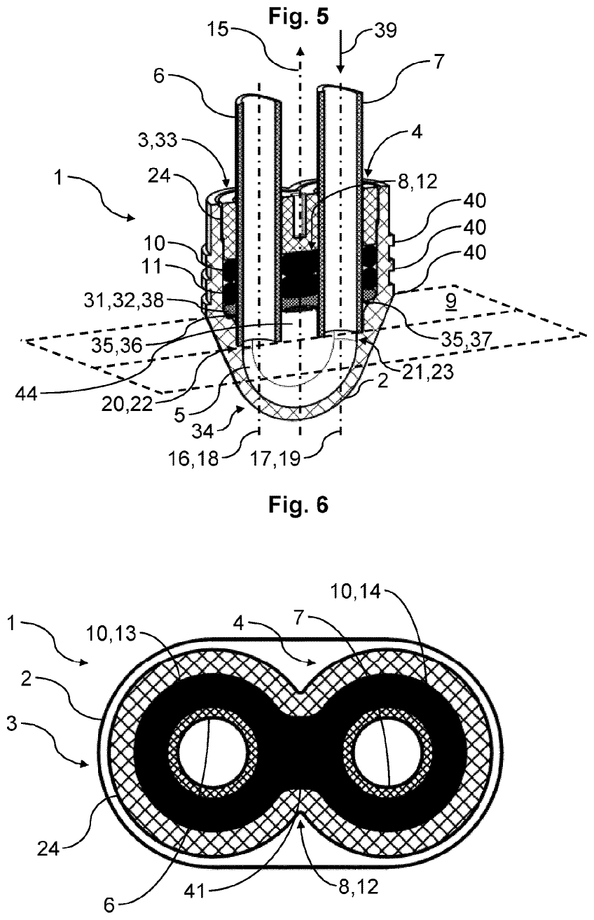

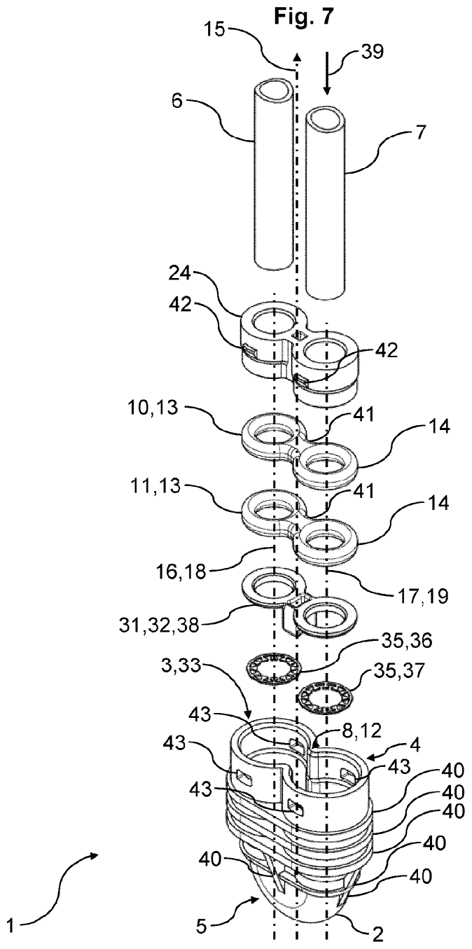

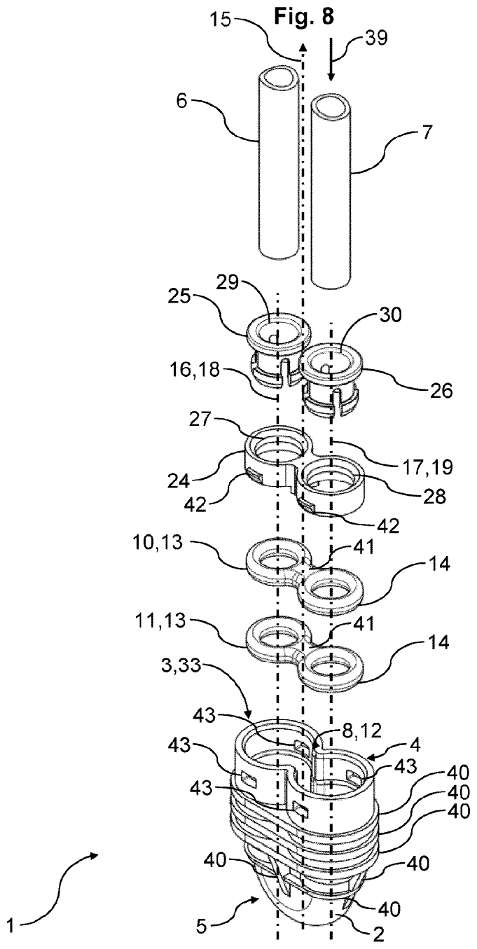

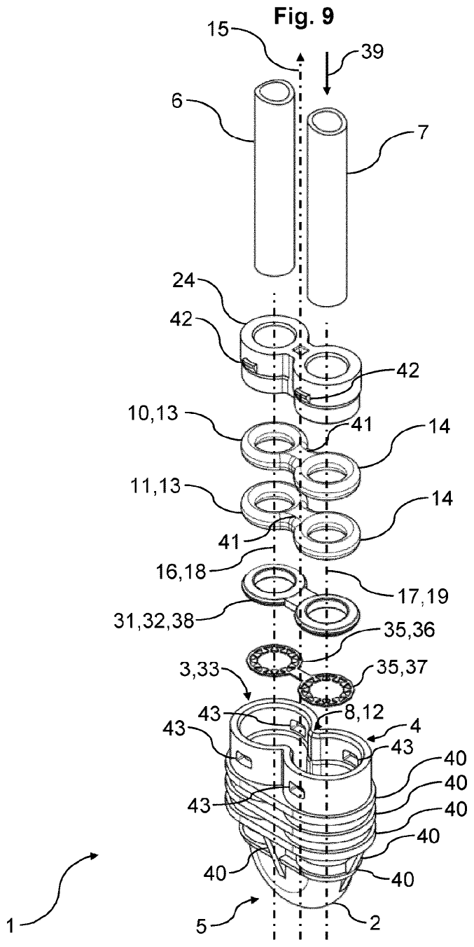

The figures show three exemplary embodiments of a fluidic deflection unit 1 according to the invention. The perspective external view of two exemplary embodiments is in this case identical and shown in FIG. 1. This belongs to the exemplary embodiments in FIGS. 3 and 7 and in FIGS. 5 and 9. FIG. 2 shows the external view of a further exemplary embodiment, which is also shown in FIGS. 4 and 8. The exemplary embodiments are described together in the following text.

The fluidic deflection unit 1 is suitable for use in the sanitary sector. The fluidic deflection unit 1 has a housing 2, hose receptacles 3, 4 and a connecting channel 5 fluidically connecting the hose receptacles 3, 4. A hose 6, 7 has been fitted in each of the hose receptacles 3, 4.

It is apparent in particular from the sectional illustrations in FIGS. 3 to 5 that the hose receptacles 3, 4 are each connected fluidically together in at least one axial portion 8 beyond the connecting channel 5. Furthermore, the hose receptacles 3, 4 and the connecting channel 5 are respectively arranged such that they are separable by a plane 9. In the exemplary embodiments, the fluidic deflection unit 1 has a one-piece housing 2.

In all the exemplary embodiment, at least one, specifically two sealing elements 10, 11 acting in the two hose receptacles 3, 4 is/are provided. This sealing element 10, 11 at least partially fills the fluidic connection 12 which is formed between the hose receptacles 3, 4, and consists of two mutually connected rings 13, 14, as is apparent from FIG. 6. The rings 13, 14 are O-rings in this case. In an exemplary embodiment that is not shown, the rings 13, 14 may be X-rings and/or rings with a rectangular cross-sectional area. The rings 13, 14 are connected together via a connecting web 41. Similarly, further parts inserted into the two hose receptacles 3, 4 can be connected via a respective connecting web. The hose receptacles 3, 4 are connected fluidically together along their entire course in the axial direction 15. In this case, the fluidic connection 12 is formed. Respective longitudinal axes 16, 17 of the hose receptacles 3, 4 are in this case oriented parallel to, specifically even congruently with, respective longitudinal axes 18, 19 of openings 20, 21 at the ends 22, 23 of the connecting channel 5.

The fluidic deflection units 1 furthermore each have a sleeve part 24, which has been inserted into the housing 2, specifically into the hose receptacles 3, 4, and is designed to axially guide a hose 6, 7 that is able to be fitted in the hose receptacles 3, 4. The sleeve part 24 is able to be latched together with the housing 2. To this end, the sleeve part 24 has at least one latching cam 42, specifically in each case at least one latching cam 42 per hose receptacle 3, 4, specifically two opposite latching cams 42 per hose receptacle 3, 4. The at least one, specifically each latching cam 42 can act together with an appropriately designed receiving opening 43 in the housing 2 such that the sleeve part 24 is able to be latched together with the housing 2. The sleeve part 24 is embodied in one piece for both hose receptacles 3, 4 in the exemplary embodiments and can be embodied separately for each hose receptacle 3, 4 in an embodiment that is not shown. The sleeve part 24 at least partially fills the fluidic connection 12.

The fluidic deflection unit 1 of the exemplary embodiment shown in FIGS. 2, 4 and 8 has a sleeve part 24 which comprises at least one holding part, specifically two holding parts 25, 26. The holding part 25, 26 is respectively able to be fitted on a hose 6, 7 that is able to be fitted in the hose receptacle 3, 4, and is respectively able to be fitted in a holding-part receptacle 27, 28 of the sleeve part 24 and furthermore able to be latched in place in this holding-part receptacle 27, 28. The holding part 25, 26 respectively has a receiving opening 29, 30 for a hose 6, 7 and entirely encloses said opening in the circumferential direction.

The respective sealing elements 10, 11 are embodied in the form of two mutually connected rings 13, 14 in the exemplary embodiments, and inserted into the housing 2 adjacent to respective sleeve parts 24, and designed to externally seal two hoses 6, 7 that are able to be fitted in the hose receptacles 3, 4.

The fluidic deflection units 1 of the exemplary embodiments in FIGS. 1, 3 and 7 and 1, 5 and 9 each have an insert part 31, which is arranged adjacent to the respective sealing elements 11, and has been inserted into the housing 2. The insert part 31 forms a planar support surface 32 transversely to the direction of a longitudinal axis 16, 17 of a hose receptacle 3, 4 on the side 34 thereof remote from a housing opening 33.

The exemplary embodiment of a fluidic deflection unit 1 shown in FIGS. 1, 5 and 9 has a holding element 35, which consists of at least one, specifically two toothed rings 36, 37, on a side 34 of a hose receptacle 3, 4 that is remote from a housing opening 33, in order to fix a hose 6, 7 that is able to be fitted in the hose receptacle 3, 4. The holding element 35 is in one piece for both hose receptacles 3, 4 and likewise embodied in the form of toothed rings 36, 37, and at least partially fills the fluidic connection 12. In both cases, a respective counter bearing 38 for the holding element 35, specifically in the form of the insert part 31, is formed adjacent to the holding element 35.

The exemplary embodiment of a fluidic deflection unit 1 shown in FIG. 4 has two holding parts 25, 26 that are embodied separately for each hose receptacle 3, 4 and may be embodied in one piece for both hose receptacles 3, 4 in an exemplary embodiment that is not shown. The shown holding parts 25, 26 each at least partially fill the fluidic connection 12.

The exemplary embodiments in FIGS. 1, 3 and 5 each have insert parts 31 that are embodied in one piece for both hose receptacles 3, 4 and at least partially fill the fluidic connection 12. In an exemplary embodiment that is not shown, the insert part 31 may be embodied separately for each hose receptacle 3, 4.

In all the exemplary embodiments, the housing 2 of the fluidic deflection unit 1 externally has at least one, specifically three reinforcing ribs 40 extending transversely to a fitting direction 39 of a hose 3, 4. Further reinforcing ribs 40 on the housing are oriented partially in the axial direction 15 or inclined with respect thereto.

In the shown exemplary embodiments of fluidic deflection units 1, with fitted hoses 6, 7, the use according to the invention of a hose 6, 7 for interrupting a fluidic connection 12 in a fluidic deflection unit 1 is also realized, wherein the hose 6, 7 is fitted in a hose receptacle 3, 4, into which the fluidic connection 12 leads, and wherein the connecting channel 5 continues to be open.

The fluidic connection 12, which fluidically connects the hose receptacles 3, 4, forms, together with the connecting channel 5, a common interior 44 of the housing 2.

In FIG. 3, a filling protrusion 45 is formed on the insert part 31, said filling protrusion 45 projecting toward the connecting channel 5 and filling an intermediate space between the ends of the fitted hoses 6, 7. In this way, dead space in which water is not flushed out or is not fully flushed out during use can be reduced.

Thus, a fluidic deflection unit 1 is proposed which is suitable in particular for use in the sanitary sector. The fluidic deflection unit 1 has, in this case, a housing 2, two hose receptacles 3, 4 and a connecting channel 5 fluidically connecting the hose receptacles 3, 4. In this case, the hose receptacles 3, 4 are connected fluidically together, in particular in at least one axial portion 8, beyond the connecting channel 5, in particular wherein the hose receptacles 3, 4 and the connecting channel 5 are respectively arranged such that they are separable by a plane 9. Furthermore, the use of a hose 6, 7 for interrupting a fluidic connection 12 in a fluidic deflection unit 1 according to the invention is proposed, wherein the hose 6, 7 is fitted in a hose receptacle 3, 4 into which the fluidic connection 12 leads, in particular wherein the connecting channel 5 continues to be open.

### LIST OF REFERENCE SIGNS

1 Fluidic deflection unit
2 Housing
3 Hose receptacle
4 Hose receptacle
5 Connecting channel
6 Hose
7 Hose
8 Axial portion
9 Plane
10 Sealing element
11 Sealing element
12 Fluidic connection
13 Ring
14 Ring
15 Axial direction
16 Longitudinal axis
17 Longitudinal axis
18 Longitudinal axis
19 Longitudinal axis
20 Opening
21 Opening
22 End
23 End
24 Sleeve part
25 Holding part
26 Holding part
27 Holding-part receptacle
28 Holding-part receptacle
29 Receiving opening
30 Receiving opening
31 Insert part
32 Support surface
33 Housing opening
34 Side
35 Holding element
36 Toothed ring
37 Toothed ring
38 Counter bearing
39 Fitting direction
40 Reinforcing rib
41 Connecting web
42 Latching cam
43 Opening
44 Interior
45 Filling protrusion

1. A fluidic deflection unit (1), comprising:
a housing (2);
two hose receptacles (3, 4) in the housing (2);
a connecting channel (5) in the housing (2) fluidically connecting the hose receptacles (3, 4), characterized in that and the hose receptacles (3, 4), beyond the connecting channel (5), are connected fluidically together by a fluidic connection (12), and the hose receptacles (3, 4) and the connecting channel (5) are respectively arranged such that they are separable by a plane (9); and
a sealing element (10, 11) that acts in both of the hose receptacles (3, 4) at least partially fills the fluidic connection (12) and/or is formed of two mutually connected rings (13, 14).

2. The fluidic deflection unit (1) as claimed in claim 1, the wherein the housing (2) is a one-piece housing (2).

3. (canceled)

4. The fluidic deflection unit (1) as claimed in claim 1, wherein the hose receptacles (3, 4) are connected fluidically together along an entire course in an axial direction (15), and/or the fluidic connection (12), fluidically connecting the hose receptacles (3, 4), and the connecting channel (5) form a common interior of the housing (2).

5. The fluidic deflection unit (1) as claimed in claim 1, wherein respective longitudinal axes (16, 17) of the hose receptacles (3, 4) are oriented parallel to respective longitudinal axes (18, 19) of openings (20, 21) at the ends of the connecting channel (5).

6. The fluidic deflection unit (1) as claimed in claim 1, further comprising a sleeve part (24) inserted into the housing (2), and being configured to axially guide a hose (6, 7) that is adapted to be fitted in the hose receptacle (3, 4), the sleeve part (24) is latched or latchable together with the housing (2), and the sleeve part (24) comprises two sleeve parts, each embodied separately for each respective one of the hose receptacles (3, 4) or the sleeve part (24) is formed in one piece for both of the hose receptacles (3, 4) and/or at least partially fills the fluidic connection (12).

7. The fluidic deflection unit (1) as claimed in claim 6, wherein the sleeve part (24) has at least one latching cam (42) per hose receptacle (3, 4).

8. The fluidic deflection unit (1) as claimed in claim 7, wherein the at least one latching cam (42) is adapted to act together with an appropriately designed receiving opening (43) in the housing (2) such that the sleeve part (24) is latchable together with the housing (2).

9. The fluidic deflection unit (1) as claimed in claim 6, wherein the sleeve part (24) comprises at least one holding part (25, 26), said holding part (25, 26) is adapted to be fitted on a hose (6, 7) that is adapted to be fitted in the hose receptacle (3, 4), and is adapted to be fitted in a holding-part receptacle (27, 28) of the sleeve part (24), and the holding part (25, 26) comprises two holding parts, each embodied separately for each respective one of the hose receptacles (3, 4), or the holding part is formed in one piece for both of the hose receptacles (3, 4) and/or at least partially fills the fluidic connection (12).

10. The fluidic deflection unit (1) as claimed in claim 9, wherein the holding part (25, 26) has a receiving opening (29, 30) for a hose (6, 7) and is adapted to entirely enclose the hose in a circumferential direction.

11. The fluidic deflection unit (1) as claimed in claim 1, wherein the sealing element (10, 11), is fitted next to a sleeve part (24) inserted into the housing (2) and being configured to axially guide a hose (6, 7) that is adapted to be fitted in the hose receptacle (3, 4), into the housing (2) and is adapted to externally seal two hoses (6, 7) that are adapted to be fitted in the hose receptacles (3, 4).

12. The fluidic deflection unit (1) as claimed in claim 1, further comprising an insert part (31) inserted into the housing (2) that forms a planar support surface (32) transversely to a direction of a longitudinal axis (16, 17) of the hose receptacle (3, 4) on a side (34) thereof remote from a housing opening (33), and the insert part (31) comprises two insert parts, each embodied separately for each respective one of the hose receptacles (3, 4), or the insert part (31) is formed in one piece for both of the hose receptacles (3, 4) and/or at least partially fills the fluidic connection (12).

13. The fluidic deflection unit (1) as claimed in claim 1, further comprising a holding element (35) formed on a side (34), remote from a housing opening (33), of the hose receptacle (3, 4) that is adapted to fix a hose (6, 7) that is adapted to be fitted in the hose receptacle (3, 4), a counter bearing (38) for the holding element (35) formed adjacent to the holding element (35), and the holding element (35) comprises two holding elements, each embodied separately for each respective one of the hose receptacles (3, 4) or the holding element (35) is formed in one piece for both of the hose receptacles (3, 4) and/or at least partially fills the fluidic connection (12).

14. (canceled)

15. (canceled)

16. The fluidic deflection unit (1) as claimed in claim 1, wherein the housing (2) has, externally, at least one reinforcing rib (40) extending preferably transversely to a fitting direction (39) for insertion of a hose (6, 7).

17. The fluidic deflection unit (1) as claimed in claim 1, further comprising a filling protrusion (45) that projects toward the connecting channel (5), and at least partially fills an intermediate space between ends of the fitted hoses (6, 7).

18. An assembly, comprising: the fluidic deflection unit (1) as claimed in claim 1, and hoses (6, 7) fitted in the hose receptacles (3, 4) into which the fluidic connection (12) leads, wherein the connecting channel (5) continues to be open.

19. The fluidic deflection unit (1) as claimed in claim 6, wherein the sleeve part (24) is inserted into the housing (2).

20. The fluidic deflection unit (1) as claimed in claim 7, wherein the at least one latching cam (42) comprises two opposite latching cams (42) for each of the hose receptacles (3, 4).
